(19) United States
(12) Patent Application Publication
(10) Pub. No.: US 2006/0208082 A1
(43) Pub. Date: Sep. 21, 2006

(54) Scanner with variable scan range

(75) Inventors: Chao-Ping Lee, Suzhou (CN); Ming-Kuan Qian, Chiang-Su Province (CN)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/377,421

(22) Filed: Mar. 17, 2006

(30) Foreign Application Priority Data
Mar. 21, 2005 (TW) 94108574

(51) Int. Cl. G06K 7/10

(52) U.S. Cl. 235/454; 235/472.01

(57) ABSTRACT

A scanner with variable scan range. The scanner comprises a plurality of scan units and at least one joint mechanism corresponding to the scan units. The scan units are mechanically and electrically connected, and the scan range is variable for scanning objects of different sizes.

### BACKGROUND

The invention relates to a scanner with a variable scan range, and in particular to a scanner having a plurality of joined scan units which can overlap or stretch to vary the scan range.

Typically, conventional scanners have a fixed scan range, for example a scanner for A5 size documents cannot be applied to A4 size documents, or a scanner for A4 size documents cannot be applied to A3 size documents. When documents of various sizes are to be scanned, various scanners with different scan ranges or one scanner with a large scan range, which often occupies excessive space, must be employed.

### SUMMARY

An embodiment of a scanner are provided. The scanner comprises a plurality of scan units and at least one corresponding joint mechanism. The scan units are mechanically and electrically connected, and the scan range is variable for scanning objects of different sizes.

The joint mechanism comprises a pivot member on each scan unit, whereby the scan units are made rotatable to overlap or stretch. The pivot member can be a hinge.

The joint mechanism comprises at least one guide member on one scan unit and at least one curved groove on another scan unit. The guide member is slidably disposed in the curved groove to enable the scan units to rotate and overlap or stretch. The guide member can be a cylinder or a semi-cylindrical shaft.

Each scan unit has a feed slot for the scanned object. In some embodiments, the joint mechanism comprises two guide members and two semicircular grooves disposed on two sides of the feed slot respectively. The two semicircular grooves correspond and form a substantially circular groove. When the scanner is folded by overlapping the scan units, both sides of the scanned object can be scanned. When the scanner is stretched by unfolding the overlapping scan units, a single side of the scanned object can be scanned.

A first scan unit has at least one protrusion, while a second scan unit has at least one hole. The scan units are positioned by means of the protrusion engaging the hole when the scan units overlap or stretch.

The joint mechanism comprises at least one protrusion on one scan unit and at least one opening on another scan unit. The protrusion engages the opening to join the scan units, thereby adjusting the scan range of the scanner.

### BRIEF DESCRIPTION OF THE DRAWINGS

The invention can be more fully understood by reading the subsequent detailed description and examples with references made to the accompanying drawings, wherein:

FIG. 1 is a perspective view of an embodiment of a scanner of this invention;

FIGS. 2a, 2b and 2c show the scanner of FIG. 1 switching among different scan ranges;

FIG. 3a is a perspective view of another embodiment of a scanner;

FIG. 3b is schematic view shows the scanner of FIG. 3a scanning documents;

FIG. 4a is a perspective view shows the scanner of FIG. 3a in a stretched configuration;

FIG. 4b depicts the scanner of FIG. 4a scanning a document;

FIGS. 5a and 5b depict an embodiment of a joint mechanism of the scanner of FIG. 3a;

FIG. 6 depicts the joint mechanism of FIGS. 5a and 5b joining the scan units;

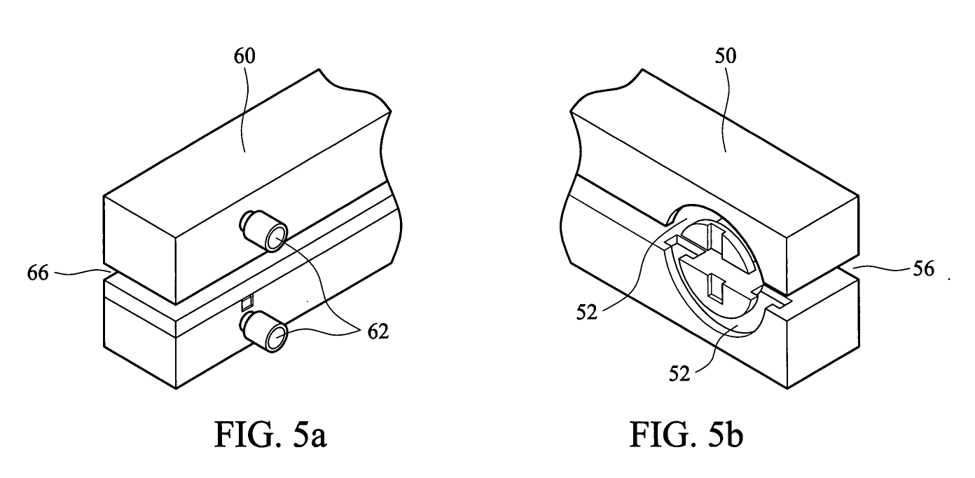

FIGS. 7a and 7b depict a signal wire of a scanner of FIG. 3a between the overlapped scan units;

FIG. 7c depicts a signal wire of a scanner of FIG. 4a between the stretched scan units;

FIGS. 8a and 8b depict another embodiment of a joint mechanism of FIG. 3a;

FIG. 9a is a schematic view of a scan unit with rollers according to the invention;

FIG. 9b is a schematic view shows the scan units of FIG. 9a scanning a document;

FIG. 10 is a schematic view of another embodiment of a scanner;

FIG. 11 depicts a joint mechanism of the scanner of FIG. 10;

FIG. 12 depicts the scanner of FIG. 10 scanning a document;

FIG. 13 is a schematic view of another embodiment of a scanner of FIG. 10;

FIG. 14 depicts the scanner of FIG. 13 scanning a document;

FIGS. 15a and 15b are schematic views shows scan units with joint mechanism of another embodiment of a scanner;

FIG. 16a depicts the scan units overlapped of a scanner of FIG. 15a;

FIG. 16b is an exploded view of the scanner of FIG. 16a;

FIG. 17a depicts the scanner of FIG. 16a in a stretched configuration; and

FIG. 17b is an exploded view of the scanner of FIG. 17a.

### DETAILED DESCRIPTION

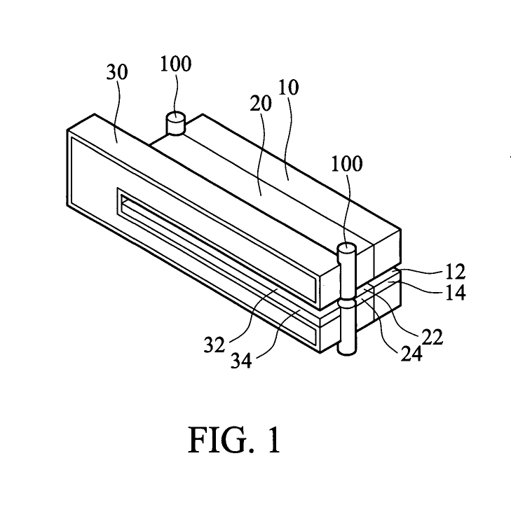

Referring to FIG. 1, a scanner 1000 comprises scan units 10, 20, 30 and a pivot member 100. The scan units 10, 20 and 30 are joined by the pivot member 100. The joined scan units 10, 20 and 30 rotate to overlap or stretch to vary the scan range. In this embodiment, the pivot member 100 is a hinge. Feed slots 12, 22 and 32 are defined on the scan unit 10, 20 and 30 respectively for feeding the documents to be scanned. Data reading devices 14, 24 and 34 are disposed on the inner wall of the feed slots 12, 22 and 32 for scanning the passing documents.

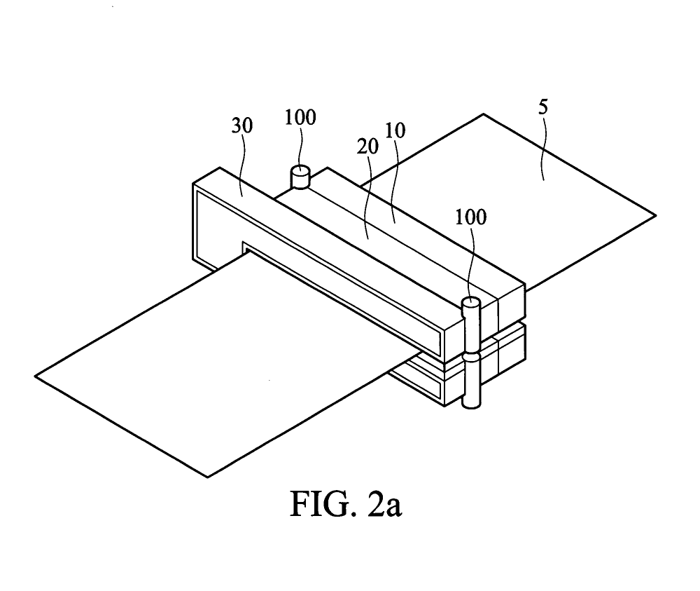

In FIG. 2a, a 4 inch photo is passing the feed slots 12, 22 and 32. As the scan units 10, 20 and 30 overlap, one, two or all three of the scan units 10, 20 and 30 can be selected to function when the document passes therethrough. In FIG. 2b, scan unit 30 is rotated to align with the scan unit 20, thus, the scan range is enlarged, and a larger document 7 of A4 size, for example, can be accepted. At this time, either the scan units 20 or 30 is selected to function. In FIG. 2c, all the scan units 10, 20 and 30 are stretched to the maximum scan range, and capable of accepting an even larger document such as A3 size. Although three scan units are described in this embodiment, it is not limited thereto. Two scan units, four scan units or more scan units can be employed.

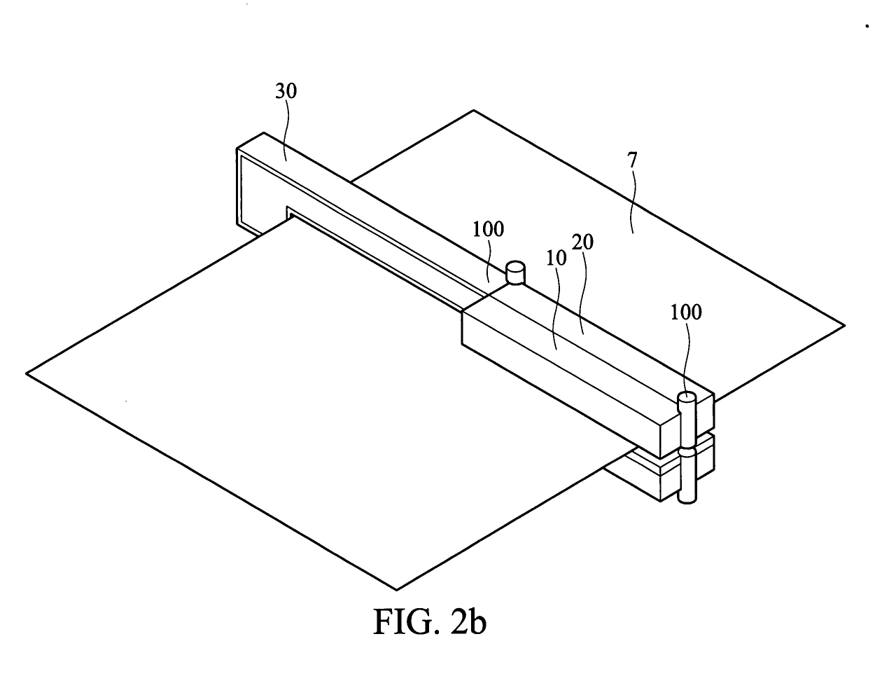

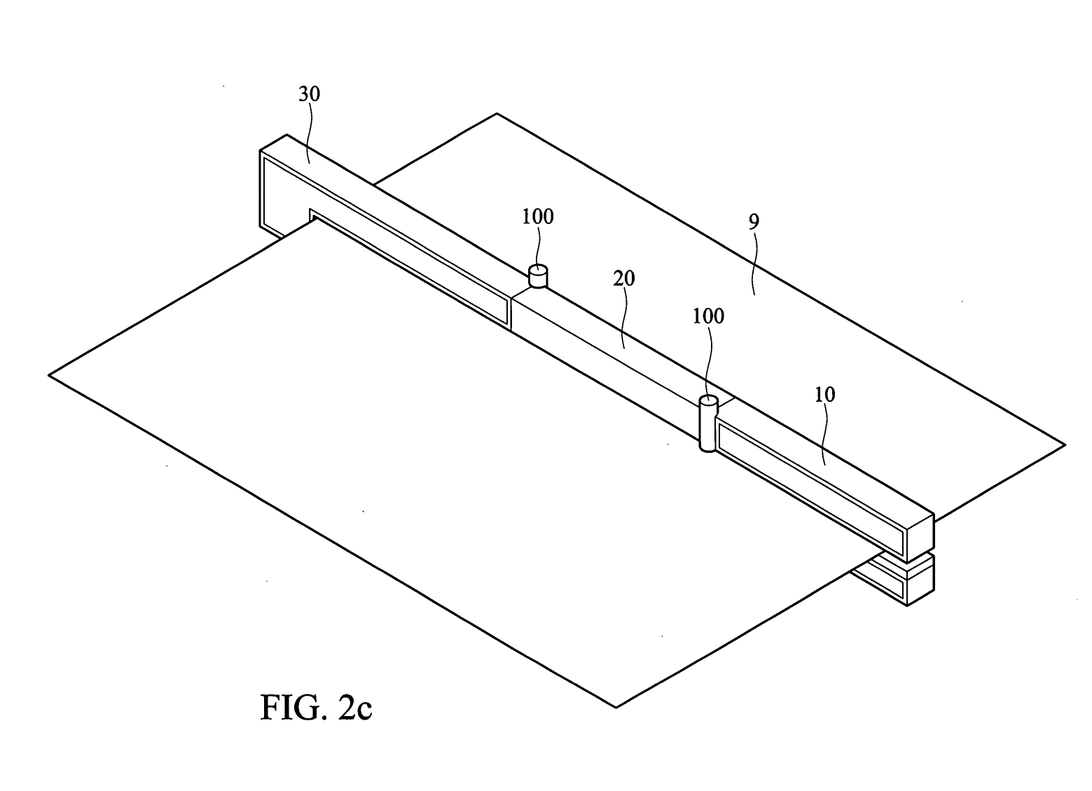

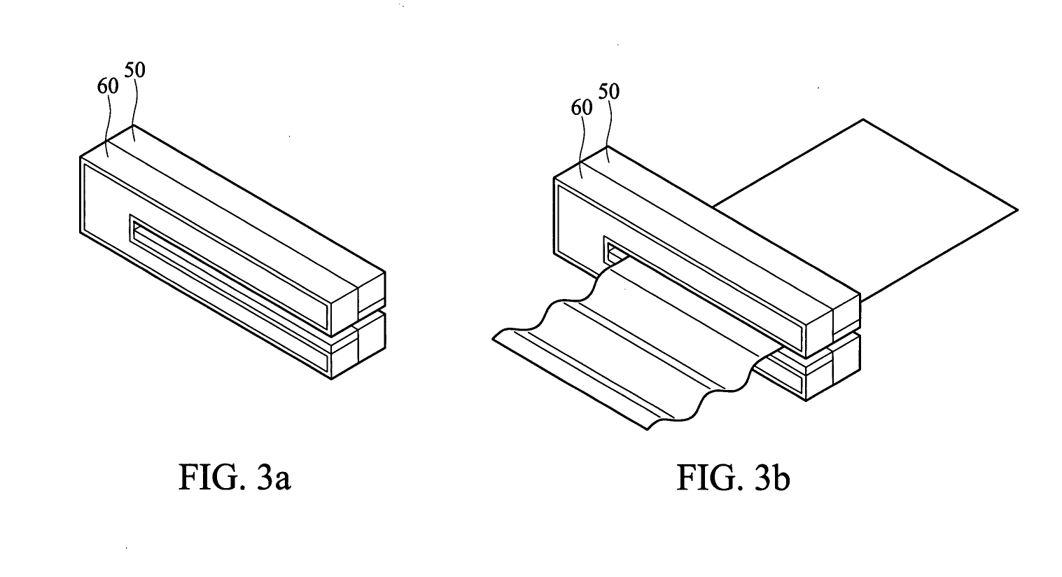

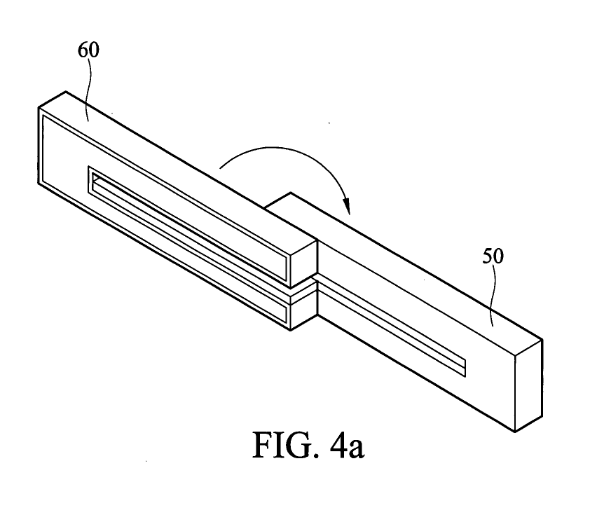

FIG. 3a depicts another embodiment of the scanner of the invention. A scanner 1000 comprises a scan unit 50 and 60. The scan units 50 and 60 can overlap as shown in FIG. 3b, or the scan unit 50 can rotate clockwise to stretch, thereby enlarging the scan range as shown in FIG. 4b. The joint mechanism between the scan units 50 and 60 is described in the following.

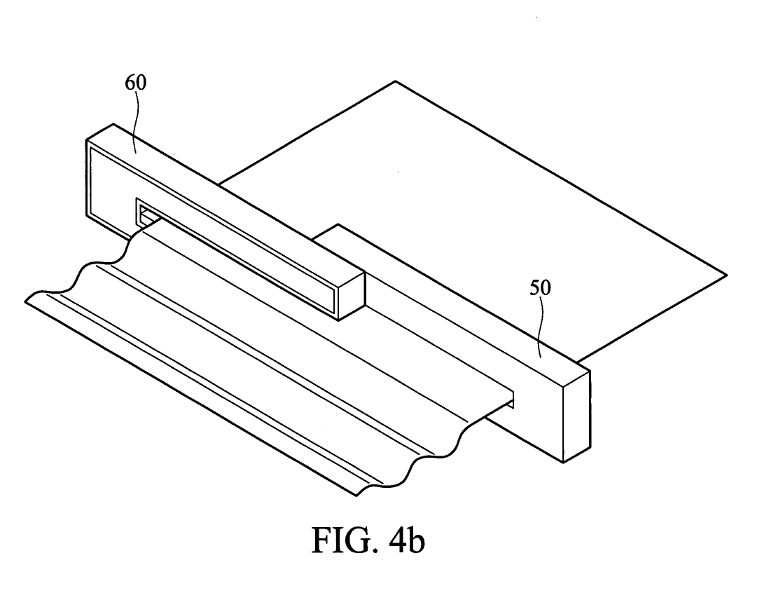

FIGS. 5a and 5b depicts the joint mechanism between the scan units 50 and 60. Two guide members 62 are disposed on the scan unit 60 and adjacent to a feed slot 66 as shown in FIG. 5a. In this embodiment, the guide member 62 is a cylinder. Two semicircular grooves 52 are formed on the scan unit 50 and adjacent to a feed slot 56 as shown in FIG. 5b. The guide members 62 slide in the grooves 52 enabling the scan units 50 and 60 to rotate, whereby the scan units 50 and 60 stretch to accommodate large size documents.

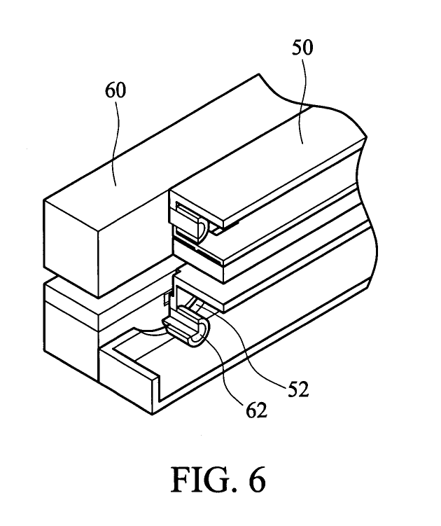

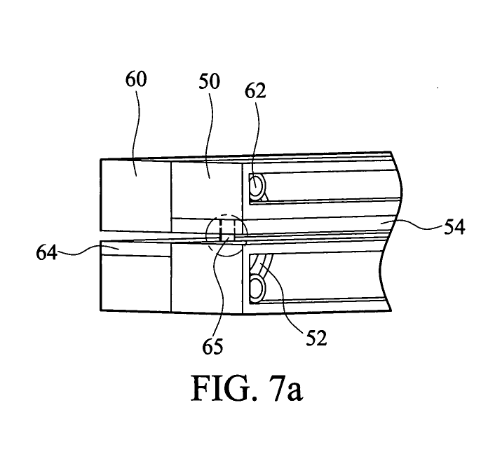

As the scan units 50 and 60 are rotated to overlap or stretch as shown in FIGS. 3a and 4a respectively, a data reading device 54 of the scan unit 50 and a data reading device 64 of the scan unit 60 must be disposed on the upper inner wall of the feed slots 56 and the lower inner wall of the feed slot 66 so as to scan the double sides of a scanned document as shown in FIG. 7a. In such a structure, when the scan unit 50 is rotated to stretch, the data reading devices 54 and 64 are positioned on the same side of the scanned document, whereby a large size document can be scanned.

A signal wire 65 is provided to connect the data reading devices 54 and 64 electrically. When the scan units 50 and 60 overlap, as the data reading devices 54 and 64 are on opposite sides of the scanned document, the signal wire 65 connecting the data reading devices 54 and 64 extends cross the feed slots 56 and 66 as shown in FIG. 7b. As the signal wire 65 are disposed near the ends of the scan units 50 and 60, the scanned document can pass without interference from the signal wire 65. In FIG. 7b, the scan unit 50 is omitted to clearly show the signal wire 65. When the scan unit 50 is rotated 180° and stretched, the signal wire 65 is also rotated. Thus, when the scan units 50 and 60 are stretched, signal wire 65 is disposed on the same side and does not extend across the feed slots 56 and 66.

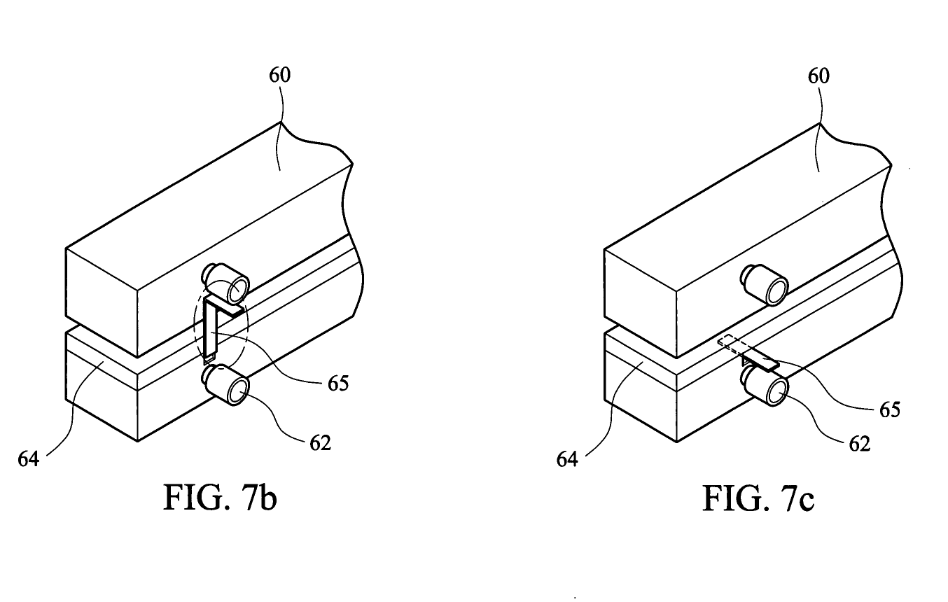

In this embodiment, another type of the joint mechanism can be employed. As shown in FIGS. 8a and 8b, the joint mechanism comprises two semi-cylindrical shafts 67 and a depression 57 in which the shafts 67 are rotatably inserted, whereby the scan units 50 and 60 overlap or stretch. Additionally, the scan unit 60 further comprises a plurality of protrusions 63, and the scan unit 50 further comprises a plurality of holes 53 corresponding to the protrusion 63. The protrusions 63 engage the holes 53 to position the scan units 50 and 60 when the scan units 50 and 60 overlap or stretch.

In the described embodiments, the scan units rotate to overlap or stretch. In the following embodiment, however, another type of joint mechanism is described.

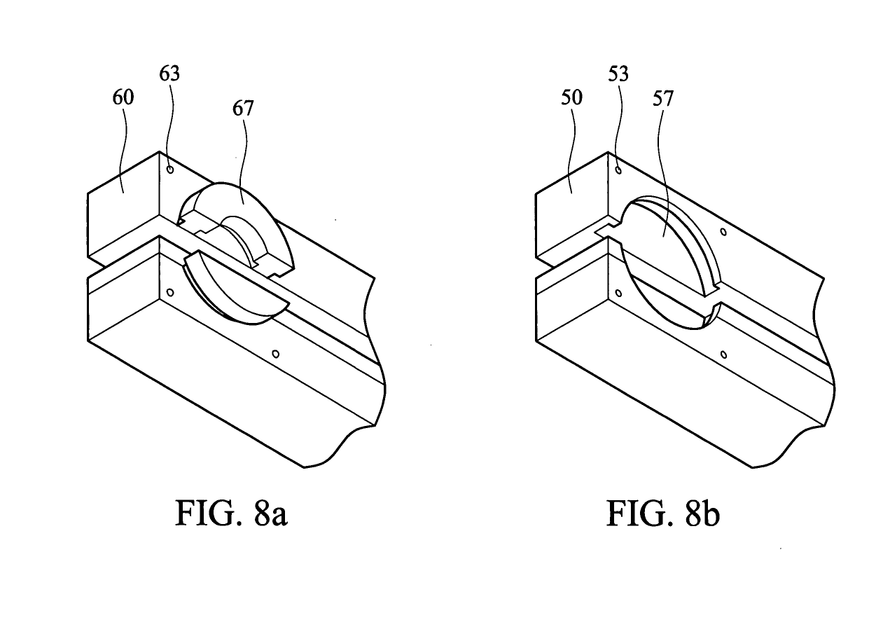

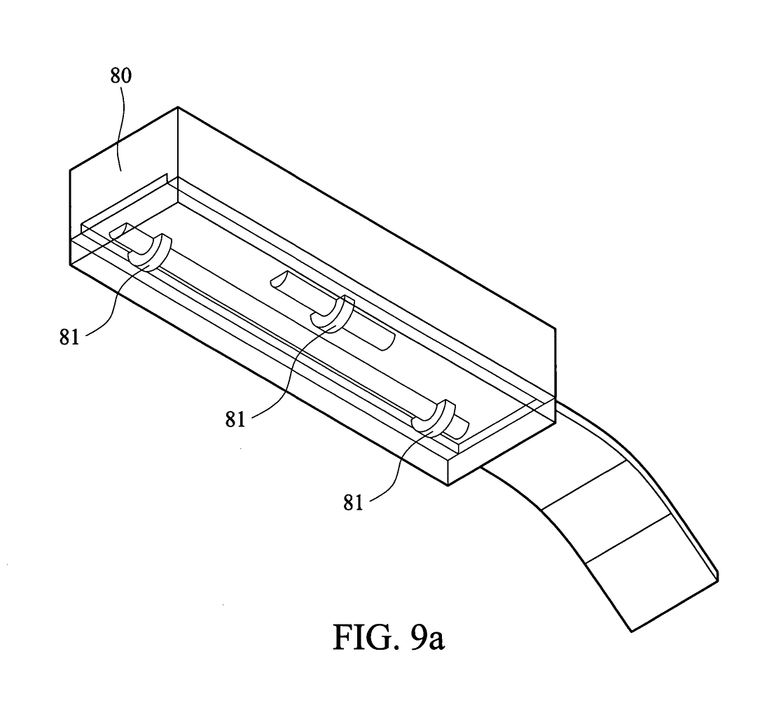

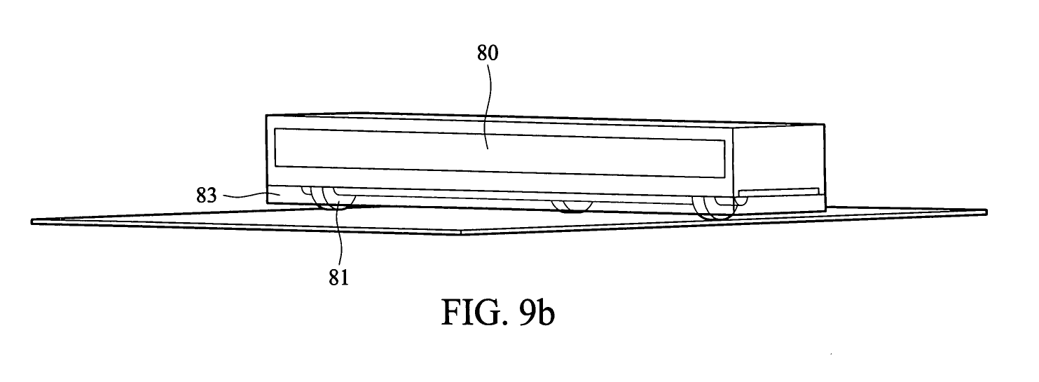

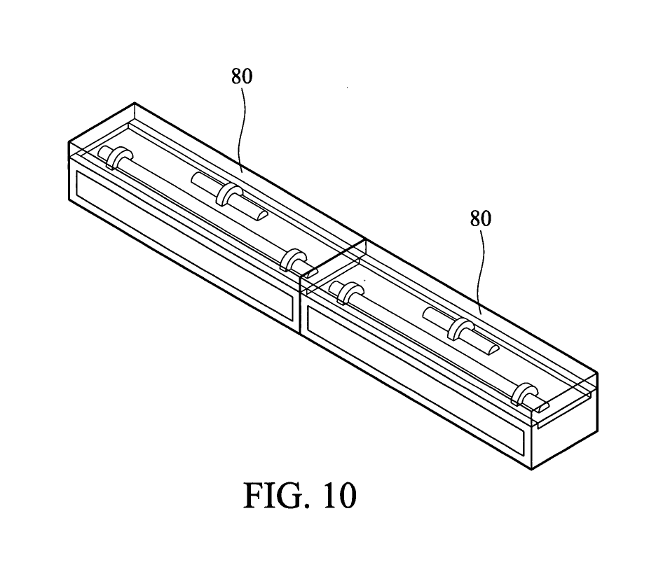

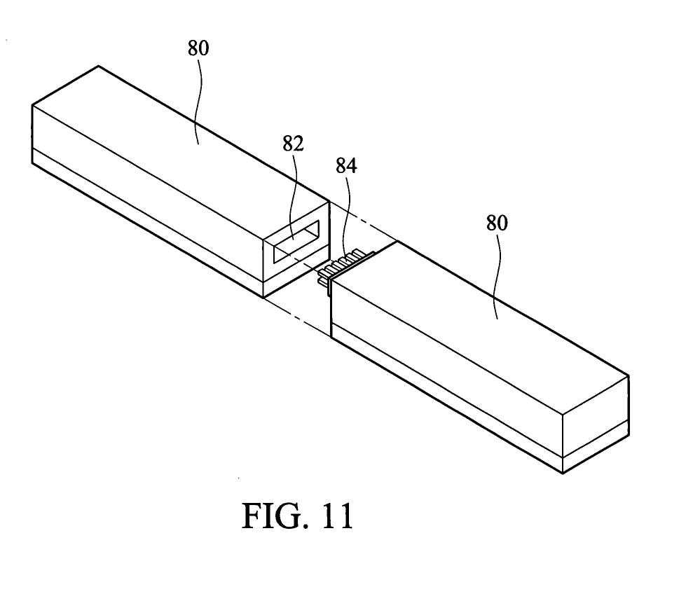

FIG. 9a depicts a scan unit with rollers. A scan unit 80 comprises at least one roller 81 on the bottom and a data reading device 83 also on the bottom. When a document is scanned, the scan unit 80 is rolled on the document, and the data reading device 83 reads the data on the document simultaneously as shown in FIG. 9b. In such circumstance, the joint mechanism between two scan units 80 comprises a plug (protrusion) 84 on one scan unit 80 and an opening 82 on another scan unit 80 as shown in FIG. 11. Two scan units 80 are joined by inserting the plug 84 into the opening 82 as shown in FIGS. 10 and 12. In addition to mechanical connection, electrical connection can also be accomplished by this joint mechanism.

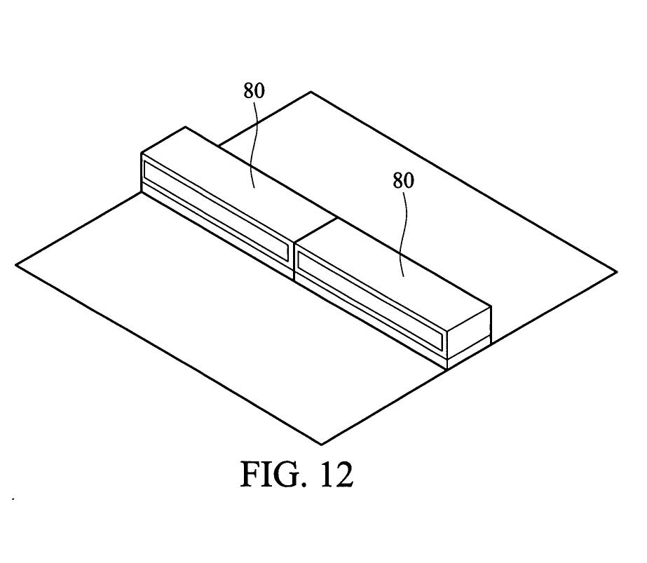

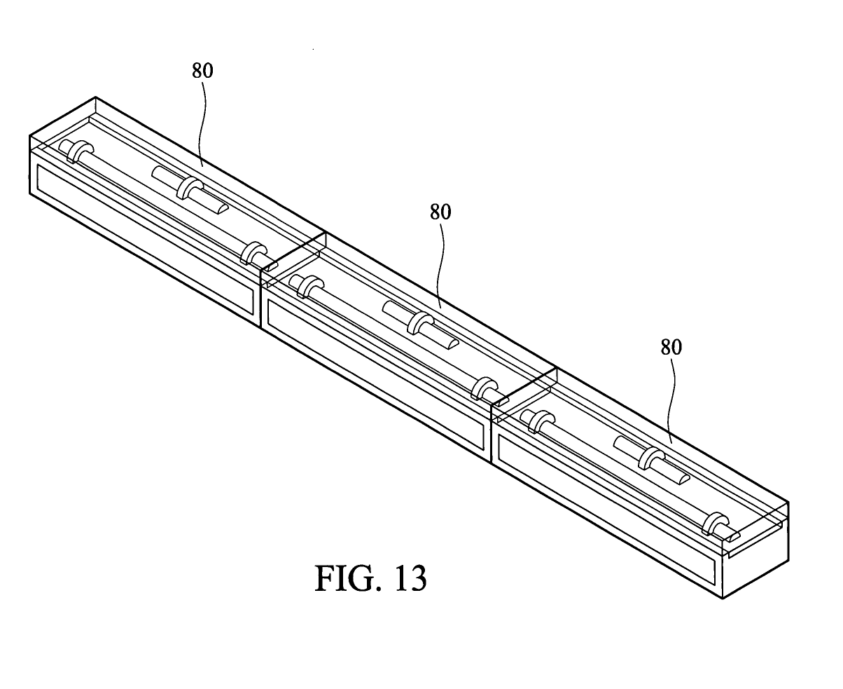

In this embodiment, more than two scan units 80 are applicable. For example, three scan units 80 can also be joined in this way as depicted in FIGS. 13 and 14.

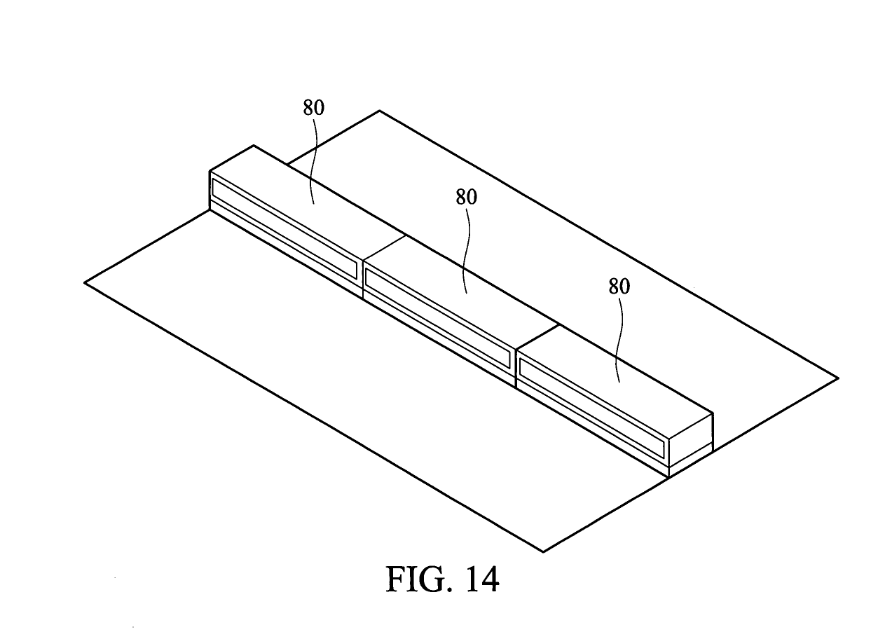

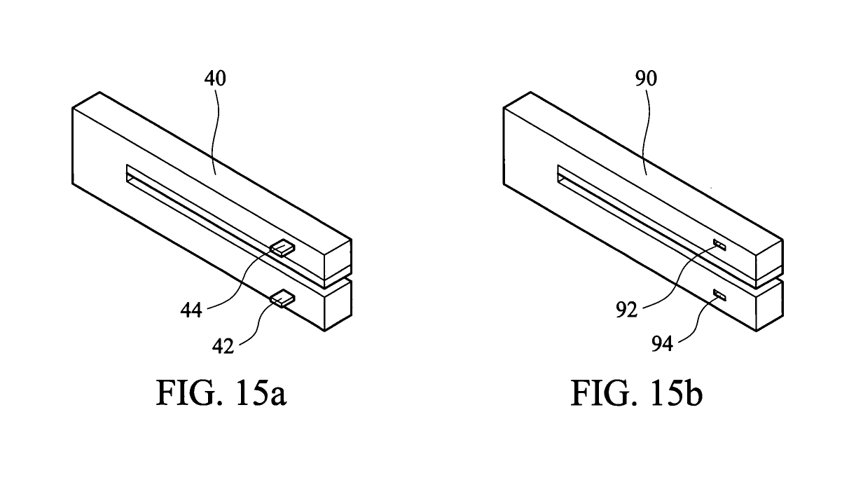

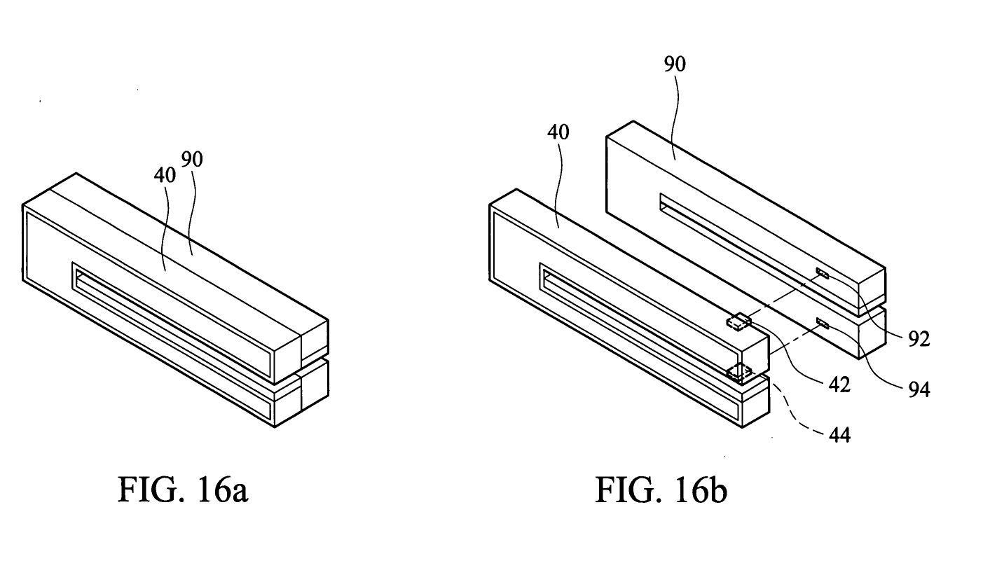

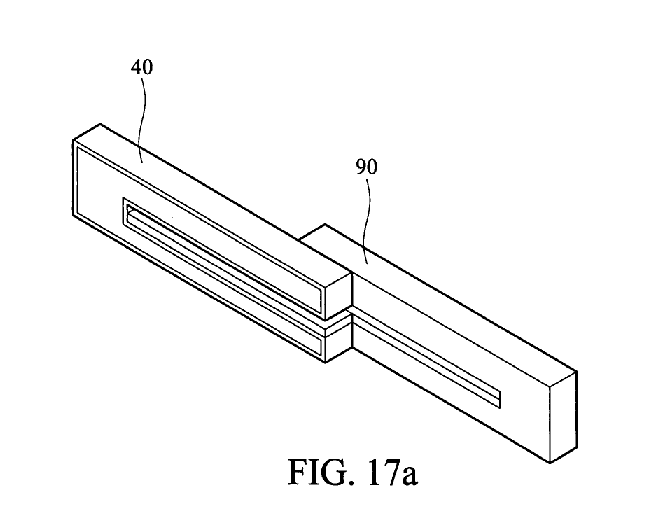

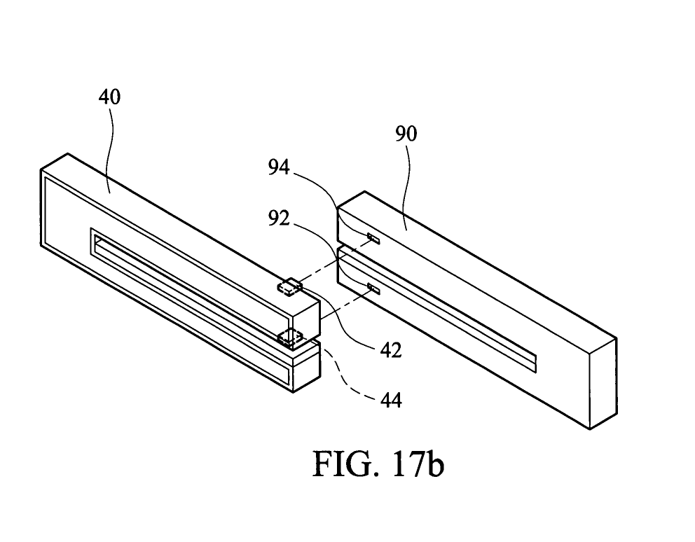

FIGS. 15a and 15b depict another embodiment of the plug-in type scanner. A scan unit 40 comprises a first pin 42 and a second pin 44, and a scan unit 90 comprises a first pin hole 92 and a second pin hole 94. When scan units 40 and 90 overlap, as shown in FIG. 16a, the first pin 42 and the second pin 44 are inserted into the first pin hole 92 and the second pin hole 94 respectively as shown in FIG. 16b. The scan unit 90 is separated from the scan unit 40 and rotated 180° to enable insertion of the first pin 42 and the second pin 44 into the second pin hole 94 and the first pin hole 92, thereby the scan units 40 and 90 stretching to enlarge the scan range as depicted in FIGS. 17a and 17b. In addition to mechanical connection, the scan units 40 can also be electrically connected to the scan unit 90 by protrusion of the first pin 42 and the second pin 44 into the first pin hole 92 and the second pin hole 94.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A scanner, comprising:
a plurality of scan units;
at least one joint mechanism corresponding to the scan units, whereby the scan units are mechanically and electrically connected, and the scan range is variable for scanning objects of different sizes.

2. The scanner as claimed in claim 1, wherein the joint mechanism comprises a pivot member on the scan units, whereby the scan units are rotatable to overlap or stretch.

3. The scanner as claimed in claim 2, wherein the pivot member is a hinge.

4. The scanner as claimed in claim 1, wherein the joint mechanism comprises at least one guide member on one scan unit and at least one curved groove on another scan unit, and the guide member slidably disposed in the curved groove to enable the scan units to rotate to overlap or stretch.

5. The scanner as claimed in claim 4, wherein the guide member is a cylinder.

6. The scanner as claimed in claim 4, wherein the guide member is a semi-cylindrical shaft.

7. The scanner as claimed in claim 4, wherein each scan unit has a feed slot for the scanned object, the joint mechanism comprises two guide members and two semicircular grooves disposed on two sides of the feed slot respectively, wherein the two semicircular grooves correspond to form a substantially circular groove.

8. The scanner as claimed in claim 7, wherein the guide member is a cylinder.

9. The scanner as claimed in claim 7, wherein the guide member is a semi-cylindrical shaft.

10. The scanner as claimed in claim 4, wherein when the scanner is folded by overlapping the scan units, two sides of an object are scanned, and when the scanner is stretched by unfolding the overlapping scan units, a single side of an object is scanned.

11. The scanner as claimed in claim 4, wherein the scan unit has at least one protrusion, and the other scan unit has at least one hole, when the scan units overlap or stretch, the scan units are positioned by means of the protrusion engaging the hole.

12. The scanner as claimed in claim 1, wherein the joint mechanism comprises at least one protrusion on one scan unit and at least one opening on another scan unit, and the protrusion engages the opening to join the scan unit with the another scan unit, thereby changing the scan range of the scanner.

13. The scanner as claimed in claim 12, wherein each scan unit has at least one roller, whereby an object is scanned by the scanner rolls thereon.

14. The scanner as claimed in claim 12, wherein the protrusion engages the opening to enable the scan units to overlap or stretch.
